(19) United States
(12) Patent Application Publication
(10) Pub. No.: US 2016/0357517 A1
(43) Pub. Date: Dec. 8, 2016

(54) PROGRAMMING INTERFACE DEVICE FOR GENERATING DEDICATED COMPUTER SERVICE PROGRAMMES FOR USING SHARED COMPUTER RESOURCES

(71) Applicant: BULL SAS, Les Clayes Sous Bois (FR)

(72) Inventors: Marc LEVRIER, Saint-Cyr-sous-Dourdan (FR); Patrice CALEGARI, Boissy-sous-Saint-Yon (FR); Sébastien LACOUR, Toulouse (FR); Pawel BALCZYNSKI, Lodz (PL)

(21) Appl. No.: 15/172,563

(22) Filed: Jun. 3, 2016

(30) Foreign Application Priority Data
Jun. 3, 2015 (FR) 1555034

(51) Int. Cl. G06F 9/44; H04L 29/08

(52) U.S. Cl. CPC G06F 8/30; H04L 67/10

(57) ABSTRACT

A programming interface device forms part of a network equipment that is accessible via at least one communication network and enables users to use computer resources. The device includes an interface component configured to propose to users computer objects and functions relating to the use of computer resources, and parameterizable attributes of these computer objects and functions, and a processor configured to generate, for a user and in accordance with a chosen computer model, a dedicated computer service program for using some at least of the computer resources, by association of object(s) and/or function(s) and attribute(s) of the latter, all chosen by the user from among those proposed.

### CROSS REFERENCE TO RELATED APPLICATIONS

This application claims priority to French Patent Application No. 1555034, filed Jun. 3, 2015, the entire content of which is incorporated herein by reference in its entirety.

### FIELD

The invention relates to programming interface devices (or API (Application Programming Interfaces)) that are intended to form part of network equipment accessible via at least one communication network.

### BACKGROUND

As known by those skilled in the art, some network equipment enable users to use shared computer resources, such as for example a high performance computer (HPC) which forms part of a computer cloud, public or private, or the Internet. As an example, this allows several subsidiaries of a same group or several small or medium sized independent firms to use from time to time, for their personal needs, a same high performance computer (potentially a supercomputer).

In order that a user can effectively use some at least of these computer resources, the user needs to generate beforehand a dedicated computer service programme for using these computer resources. Such a dedicated computer programme may be generated by a user with the aid of a programming interface device (or API) forming part of a network equipment managing the use of the computer resources. It will be noted that a same dedicated computer programme designed by a user may potentially serve for several other different users, within the scope, for example, of an automated remote computing management service (of “HPC-as-a-Service” type).

Unfortunately, since this programming interface device has been designed by the owner of the network equipment, it imposes the methodologies and ergonomics of the owner on all its users, and thus frequently proves to be badly suited to the exact needs of these users.

Several APIs, intended to facilitate the generation of the aforementioned computer programmes, have already been proposed. This is for example the case of Cycleserver®, Enginframe®, Jarvice API®, Hila®, or Microsoft HPC web service® . But these APIs do not give entire satisfaction. Notably, they do not generally offer a complete high performance computing service (or “HPC-as-a-Service”), namely a service in multi-application software form (or “Software-as-a-Service”). This results notably on account of the difficulty of “uniform” exposure of intensive computing business applications that are potentially very different (mechanics, energy, finance, life sciences, electronics, media, etc.). In fact, this exposure imposes the unification of methods for managing these business applications (registration, licences, versions, parameterization, submission of computing jobs and interactive viewing of results, etc.).

### SUMMARY

An aspect of the invention notably has the aim of improving the situation.

To this end it notably proposes a programming interface device, intended to form part of a network equipment accessible via at least one communication network and enabling users to use shared computer resources, and including:
an interface component configured to propose to users computer objects and functions relating to the use of these computer resources, and parameterizable attributes of these computer objects and functions, and
a processor configured to generate, for a user and in accordance with a chosen computer model, a dedicated computer service programme for using some at least of the computer resources, by association of object(s) and/or function(s) and attribute(s) of the latter, all chosen by said user from among those proposed.

The programming interface device according to one or more embodiments of the invention may comprise other characteristics which can be taken separately or in combination, and notably:
each object may be chosen from a group including (at least) a user, a group, a project, a job, a viewing session, a resource, an application, a submission form, a licence, a cluster, a consumption of resource, a credit, an authentication service, a job scheduler, and a security mechanism;
each function may be chosen among (at least) an authentication, a statistic of use, a computing job, an execution, a planning, a management, and a computation;
the shared computer resources may constitute a high performance computer (or HPC) and/or distributed computer;
   the high performance computer may, for example, form part either of a computer cloud, or of the Internet;
the computer model chosen may, for example, be “representational state transfer” (or REST);
it may be configured in the form of a computer program product that includes a set of instructions suitable to being executed by the processor of the network equipment. Such a computer program product may thus be in the form of a set of programs enabling a service portal to interface with its target technical environment.

An aspect of the invention also proposes a network equipment, suitable to being connected to at least one communication network, and including a programming interface device of the type of that described above.

Such a network equipment may, for example, be configured in the form of a service portal (or platform).

### BRIEF DESCRIPTION OF THE DRAWING

Other characteristics and benefits of the invention will become clearer on examining the description detailed hereafter, and the appended drawing, in which:

FIG. 1 illustrates in a schematic and functional manner a network equipment equipped with an example of embodiment of a programming interface device according to an embodiment of the invention and coupled to a communication network to which are also coupled a high performance computer and communicating equipment of users.

### DETAILED DESCRIPTION

The invention notably has the aim of proposing a programming interface device DI, intended to form part of a network equipment ER which is accessible via at least one communication network RC and which enables users to use shared computer resources CH.

Hereafter, it is considered, as a non-limiting example, that the shared computer resources CH constitute a high performance computer (or HPC). But embodiments of the invention are not restricted to this type of shared computer resources. The invention also relates to computing platforms distributed in clusters in the wider sense, or remote viewing, and potentially any platform in charge of massive and/or repetitive processings using resource sharing and job scheduling mechanisms.

Furthermore, it is considered hereafter, as a non-limiting example, that the high performance computer CH forms part of a computer cloud NI. But this is not obligatory. In fact, it could form part of the Internet or a private communication network.

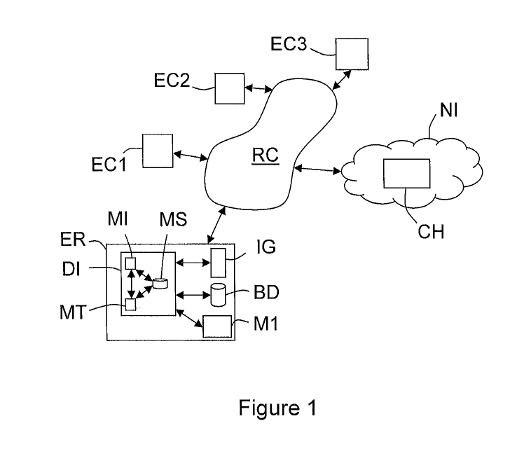

FIG. 1 schematically and functionally illustrates a communication network RC to which are coupled a network equipment RC equipped with a non-limiting example of embodiment of a programming interface device DI according to an embodiment of the invention, a computer cloud NI including a high performance computer CH (defining shared computer resources), and communicating equipment ECj of users.

In the example illustrated in a non-limiting manner, the number of communicating equipment ECj is equal to three (j=1 to 3). But this number may take any value greater than or equal to one (1).

For example, the communicating equipment ECj are individual physical computers (e.g. desktops). But this is not obligatory. They could also be portable computers (or “laptops”) or electronic tablets, for example. Generally speaking, “communicating equipment” is taken to mean herein a physical electronic equipment used by a user and having an Internet (or web) browser, a human/machine interface, such as for example a keyboard (potentially a touch keyboard), a display screen, and a communication module that can be connected to a wire communication network and/or to a wireless communication network.

The communication network RC includes, for example, a wire communication infrastructure to which can connect communicating equipment ECj, computer clouds NI, and network equipment ER, such as for example service portals (or platforms) or servers. But it could only include a wireless communication infrastructure, or instead both a wired communication infrastructure and a wireless communication infrastructure. It could also represent a set of communication networks participating in the Internet. A management of security may be envisaged, for example of VPN (Virtual Private Network) type.

The network equipment ER, which includes the programming interface device DI according to an embodiment of the invention, is, for example, a service platform (or portal) enabling users of the communicating equipment ECj to use the shared computer resources CH (here a high performance computer contained in a computer cloud NI). But it could also be a physical server.

In the non-limiting example illustrated in FIG. 1, the service platform ER also includes a graphic interface (or GUI (Graphical User interface)) IG, a database BD, and a first module M1.

The graphic interface IG is a human/machine interface enabling an authorized person to control the platform ER, and notably its programming interface device DI.

The database BD stores data defining the business objects that are necessary for the operation of a complete high performance computing service (or HPC-as-a-Service), and the life cycles thereof.

The first module M1 is charged with the authentication of users, which the programming interface device DI delegates to the authentication mechanism in place in a cloud and able to respond to various technological standards, such as for example LDAP, NIS and AD.

As illustrated in a non-limiting manner in FIG. 1, the programming interface device DI, according to an embodiment of the invention, includes at least interface component MI and processor MT. As shown in FIG. 1, the programming interface device is in communication with the graphic interface IG, the database BD and the first module M1.

This programming interface device DI is, for example, constructed in the form of software modules (or computer modules (or instead “software”)), for example of web services type. It then constitutes a computer program product including a set of instructions executable by a physical network equipment processor of electronic circuit type (or “hardware”) of the platform ER. In an embodiment, the set of instructions associated with the software modules of the programming interface are embedded or stored in one or more non-transitory computer readable media (e.g. one or more non-transitory memories). The one or more non-transitory computer readable media are in communication with the physical network equipment processor so that the physical network equipment processor can execute the instructions. Such a computer program product may thus come in the form of a set of programs enabling a service portal to interface with its target technical environment. But in a variant of embodiment the programming interface device DI could be realised in the form of a combination of software modules and one or more electronic circuits.

The interface component MI is configured to propose to users, who are connected to the platform ER by means of their communicating equipment ECj, computer objects and functions that relate to the use of the computer resources CH associated with this platform ER (here a high performance computer contained in a computer cloud NI), and parameterizable attributes (or “instantiables”) of these computer objects and functions. The interface component MI can be implemented in an embodiment in the form of machine executable instructions embedded in a non-transitory machine readable medium. The machine executable instructions are executable by a physical processor (e.g. the physical network equipment processor) to carry out the function(s) of the interface component MI.

For example, as illustrated in a non-limiting manner, the (programming interface) device DI includes a memory MS, that may be of software type, in which are stored data defining all the objects proposed, all the functions proposed, and all the attributes associated with each of these objects and each of these functions.

“Computer object” is herein taken to mean any object or concept instantiated around notions characteristic of the domain of an HPC-as-a-Service, and notably a user, a group, a project, a job, a viewing session, a resource, an application, a submission form, a licence, a cluster, a consumption of resource, a credit, an authentication service, a job scheduler, or a security mechanism.

Furthermore, “function” is herein taken to mean an action applied to at least one object, such as for example a standard authentication environment, a statistic of use of computer resources CH, a computing job, a task execution, a viewing session reservation planning, a management of data, a management of file(s), a management of server(s) and file(s) of licence(s) for application(s) specific to a business, a management of publication of applications specific to a business, a management of project(s), or a management of computing group(s) (or cluster(s)).

In the preceding the objects are the standard environment, the computer resources CH, the task, the reservation, the files, the servers, the files of licence(s) of application(s), the publication of applications, the projects, and the clusters. Furthermore, in the preceding the functions are the authentication, the statistic of use, the computing job, the execution, the planning, the management, and the computing.

It will be noted that the preceding list is not exhaustive. It may thus comprise any other object and/or any other function relating to the use of computer resources CH.

The processor MT is configured to generate, for a user so requiring it and in accordance with a chosen computer model, a dedicated computer service program (e.g. in the form machine executable instructions) for using some at least of the computer resources CH associated with the platform ER, by association of object(s) and/or function(s) and attribute(s) of the latter, which have all been chosen by the user among those that are proposed by the interface component MI. In an embodiment, the processor MT can be implemented in the form of one or more physical electrical components and/or machine executable instructions. The machine executable instructions to carry out the function(s) of the processor MT can be embedded in a non-transitory computer readable medium and executable by a physical processor (e.g. the physical network equipment processor). As shown in FIG. 1, the processor MT, memory MS and interface component MI are in communication with one another.

The generation of a dedicated (or personalized) computer program takes place by developing a software or set of machine executable instructions using a computing language supporting a call upon web services, for example of REST type. This dedicated computer program proposes a guided dialogue and/or a graphic interface (at the charge of its developer) on which the promptings of the final user trigger the call upon one or more services offered by the device DI. For example, this dedicated computer program may propose a sequencing of tasks such as: the loading of an up-to-date licence file for an HPC business application, the input of parameters for executing said HPC business application, the launch of the job, with the notification of the user in the event of error or normal end, and, potentially, the launch of a remote viewing session (in the case of success of the preceding operations) and/or export of statistics of use of the resources.

Once a dedicated computer program has been generated by the programming interface device DI for a user (under the control of the latter), it may be used by the communicating equipment ECj of this user to use some at least of the computer resources CH.

For example, as mentioned above the computer model, which is chosen to generate a dedicated computer program, is REST (REpresentational State Transfer), due to the fact that it is well adapted to Internet (or Web) and cloud environments. But this is not obligatory.

It will be noted that the programming interface device DI may be potentially configured so as to enable the generation of dedicated computer programs conforming to different chosen computer models, and notably those which differ from REST. This allows the platform ER to be used by a greater number of different types of communicating equipment ECj of users. Such a situation is notably illustrated in the non-limiting example of the single figure.

Thanks to the invention, it is henceforth possible to mask from users the great complexity of the HPC architectures and services that constitute the shared computer resources, thanks to a methodological unification. It is thus possible to mask computing job schedulers, security mechanisms and directory and authentication services, and to offer a unified presentation of one or more computing centres and one or more client organisations. Furthermore, this enables a centralisation, and if need be an outsourcing, of the computing resources, a transparent collaboration between remote partner users, a construction and a management of catalogues of application services (for example HPC), and a unification of working methods.

It will also be noted that the invention makes it possible to capitalise on any potential partial methodological unification already offered by a software editor partner or a final client, due to the fact that the services offered by the device DI make it possible to trace the manner in which the partner or the final client uses his business applications.

In particular, it will be appreciated by one skilled in the art that the disclosed programming interface device described herein represents a solution to the technological problem currently faced by designers for improving the sharing of computer resources (e.g. associated with a high performance computer) among different users.

Finally, the abstraction of certain system layers, such as the driving of licence servers for business applications (FlexLM, RLM, by key, or owners), security layers (Su, Sudo, or Kerberos) and job schedulers (SCE, PBS, LSF, SLURM, or OAR), confers an all-areas character to the invention.

The invention is not restricted to the embodiments of programming interface device and network equipment described above, only as an example, but it encompasses all the variants that those skilled in the art could envisage solely within the scope of the claims hereafter.

Having described and illustrated the principles of the invention with reference to various embodiments, it will be recognized that the various embodiments can be modified in arrangement and detail without departing from such principles. It should be understood that the devices, modules, processors, processing units, programs, processes, or methods described herein described herein are not related or limited to any particular type of computing environment, unless indicated otherwise. Various types of specialized computing environments may be used with or perform operations in accordance with the teachings described herein. Elements of embodiments shown in software may be implemented in hardware and vice versa.

Execution of the sequences of machine instructions contained in the memory causes the processor or processing unit to perform at least some of the process steps, calculations or function(s) of the procedures described herein. One or more physical processors or physical processing units in a multi-processing arrangement may also be employed to execute the sequences of instructions contained in the memory or machine/computer readable medium. In alternative embodiments, hard-wired circuitry may be used in place of or in combination with software instructions.

The term “computer readable medium” or “machine readable medium” as used herein refers to any medium that participates in providing instructions to a processor or processing unit for execution. Such a medium is non-transitory and may take many forms, including but not limited to, non-volatile media, volatile media, and transmission media. Non-volatile media include, for example, optical or magnetic disks. Volatile media include dynamic memory. Transmission media include coaxial cables, copper wire and fiber optics. Common forms of computer/machine readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer/machine readable media may be involved in carrying one or more sequences of one or more instructions to processor for execution.

1. A programming interface device for a network equipment accessible via at least one communication network and enabling users to use computer resources, the programming interface device comprising an interface component configured to propose to said users computer objects and functions relating to the use of said computer resources, and parameterizable attributes of the computer objects and functions, and a processor configured to generate, for a user and in accordance with a chosen computer model, a dedicated computer service program for using some at least of said computer resources, by association of object(s) and/or function(s) and attribute(s) of the latter, all chosen by said user from among those proposed.

2. The device according to claim 1, wherein each object is chosen from a group including a user, a group, a project, a job, a viewing session, a resource, an application, a submission form, a licence, a cluster, a consumption of resource, a credit, an authentication service, a job scheduler, and a security mechanism.

3. The device according to claim 1, wherein each function is chosen from a group including an authentication, a statistic of use, a computing job, an execution, a planning, a management, and a computation.

4. The device according to claim 1, wherein said computer resources constitute a high performance computer and/or distributed computer.

5. The device according to claim 4, wherein said high performance computer forms part either of a computer cloud (NI), or of the Internet.

6. The device according to claim 1, wherein said chosen computer model is representational state transfer.

7. The device according to claim 1, wherein the device is configured in the form of a computer programme product including a set of instructions suitable to being executed by a network component processor of said network equipment.

8. A network equipment adapted to be connected to at least one communication network, the network equipment comprising a programming interface device according to claim 1.

9. The network equipment according to claim 8, wherein the network equipment is configured in the form of a service portal.
